(19) United States
(12) Patent Application Publication
(10) Pub. No.: US 2016/0137307 A1
(43) Pub. Date: May 19, 2016

(54) DEVICE FOR CONTROLLING A THRUST OF AT LEAST ONE AIRCRAFT ENGINE

(71) Applicant: Airbus Operations (SAS), Toulouse (FR)

(72) Inventor: Brice Fernandez, Toulouse (FR)

(21) Appl. No.: 14/940,433

(22) Filed: Nov. 13, 2015

(30) Foreign Application Priority Data
Nov. 14, 2014 (FR) 1461038

(51) Int. Cl. B64D 31/04; G06F 3/0484; G06F 3/0488; B64D 31/06

(52) U.S. Cl. CPC B64D 31/04; B64D 31/06; G06F 3/04847; G06F 3/0488; G06F 3/04842

(57) ABSTRACT

A device for controlling a thrust of at least one aircraft engine. The device includes a display unit configured to display, on at least one display screen of the cockpit, indications regarding operation and at least the current engine speed of said engine of the aircraft, as well as a set of graphic elements including at least one graphic element, said graphic element or elements being configured to be able to be operated and activated by an operator to control at least one engine speed, said set of graphic elements including at least one graphic selection element configured to control the transition from the current engine speed to a preconfigured engine speed.

### CROSS-REFERENCES TO RELATED APPLICATIONS

This application claims the benefit of the French patent application No. 1461038 filed on Nov. 14, 2014, the entire disclosures of which are incorporated herein by way of reference.

### BACKGROUND OF THE INVENTION

The present invention relates to a device for controlling a thrust of at least one engine of an aircraft, in particular of a transport airplane.

It is known that in numerous aircraft, in particular those intended for civil transport, the engine speeds can be controlled individually during a flight (constituted in particular of takeoff, climbing, cruising, descent and approach phases) by control throttles associated with the engines respectively. The information regarding the speed of these engines is retransmitted to the pilot of the aircraft by means of at least one information screen located in the cockpit of the aircraft.

These throttles are located on the center pedestal next to the pilot so as to be able to be actuated easily by the pilot, whereas the screen is located opposite the pilot so as to be seen by the pilot. This difference in positioning between the control throttles and the information screen requires the pilot to visually monitor two separate points of the cockpit in particular with each change of speed of the engines: the point at which the control throttles are located and the point at which the information screen is provided. Thus, the comfort of the pilot when controlling the thrust of the engines of the aircraft may not be optimal.

### SUMMARY OF THE INVENTION

The present invention relates to a device for controlling a thrust, referred to as engine speed, of at least one engine of an aircraft, in particular of a transport airplane, making it possible to overcome this disadvantage.

To this end, the device including a display unit configured to display, on at least one display screen of the cockpit, indications regarding operation and at least the current engine speed of the aircraft engine is noteworthy, according to the invention, in that the display unit is also configured to display, on the screen, a set of graphic elements including at least one graphic element, the graphic element or elements being configured to be able to be operated and activated by an operator to control at least one engine speed, the set of graphic elements including at least one graphic selection element configured to control the transition from the current engine speed to a preconfigured engine speed.

Thus, thanks to the invention, the control makes it possible to adjust the thrust of the engines of the aircraft, and the information regarding these speeds is managed and presented by means of the same screen. The pilot may then in particular change the speed and check that the change has in fact been made thanks to the same interface located at one sole point of the cockpit, which makes it possible to overcome the aforementioned disadvantage.

In accordance with different embodiments of the invention, which can be considered together or separately:
the screen is a touchscreen on which the set of graphic elements is displayed, each of the graphic elements being able to be actuated by direct contact on the touchscreen at the location of the graphic element;
the graphic selection element or elements is/are configured to select, respectively, at least one of the following preconfigured engine speeds:
   a slowed speed;
   a maximum continuous thrust;
   a takeoff speed with reduced thrust;
   a slowed go-around speed;
   a maximum takeoff and go-around speed;
   an aircraft climbing phase speed;
   an automatic engine speed regulation intermediate speed;
the device is configured to control the speed of at least two engines, the graphic selection element being configured to control the transition from the current engine speed to a preconfigured engine speed for all of the engines;
the device is configured so that, in the event of a situation limiting the speed of a first of the engines to a limit speed, the activation of a graphic selection element corresponding to an engine speed greater than the limit speed drives the transition from the current engine speed to the limit speed for this first engine and to the greater engine speed corresponding to the activated graphic selection element for the other engine;
the device is configured, in the event of failure of a first of the engines, to automatically control the rise of the engine speed of at least one other of the engines;
the set of graphic elements includes at least one movable graphic element movable on the screen by an operator and configured in order to control the transition of the current engine speed to any engine speed, defined between a minimal engine speed and a maximum engine speed and dependent on the position on the screen of the movable graphic element;
the device is configured to control the speed of at least two engines, the set of graphic elements including a graphic activation element per engine, each of the graphic activation elements being configured so as to be actuated in order to select, independently, for each engine, a guided speed control mode or an automatic speed control mode;
the display unit is configured to display at least one of the following indications regarding the operation of the engine:
   a current engine speed;
   an engine speed change mode;
   the level of at least one preconfigured engine speed;
   the difference between a selected engine speed and the current engine speed;
   a value, in percentage, of the current engine speed in relation to a theoretical maximum engine speed;
   an automatic or guided operating mode.

The invention also relates to a method for controlling a thrust of at least one engine of an aircraft with the aid of a device as specified above. The method is noteworthy, according to the invention, in that it comprises actuating at least one graphic element displayed on the screen of the display unit of the device, the actuation of a graphic element controlling a corresponding engine speed.

In addition, the invention also relates to an aircraft, in particular a transport airplane, which comprises a device for controlling a thrust of at least one engine of the aircraft, as described above.

### BRIEF DESCRIPTION OF THE DRAWINGS

The accompanying figures will explain how the invention can be implemented. In these figures, identical references designate similar elements.

FIG. 1 schematically shows a twin-engine aircraft in plan view and also a device for controlling a thrust of at least one engine of the aircraft, shown outside the aircraft for the purpose of clarity of FIG. 1.

FIGS. 2a, 2b and 2c schematically show the device of FIG. 1, illustrating an engine speed control during takeoff of the aircraft.

FIGS. 3a, 3b and 3c schematically show the device of FIG. 1, illustrating an engine speed control between a current engine speed and a maximum engine speed.

FIGS. 4a, 4b and 4c schematically show the device of FIG. 1, illustrating engine speed control during a navigation phase (4a), descent phase (4b) and soft go-around phase (4c).

FIGS. 5a, 5b and 5c schematically show the device of FIG. 1, illustrating an engine speed control during a climbing phase of the aircraft.

FIGS. 6a and 6b schematically show the device of FIG. 1, illustrating an engine speed control when an engine speed is limited.

FIG. 7 schematically shows the device of FIG. 1, illustrating an engine speed control when the aircraft is on the ground.

### DETAILED DESCRIPTION OF THE PREFERRED EMBODIMENTS

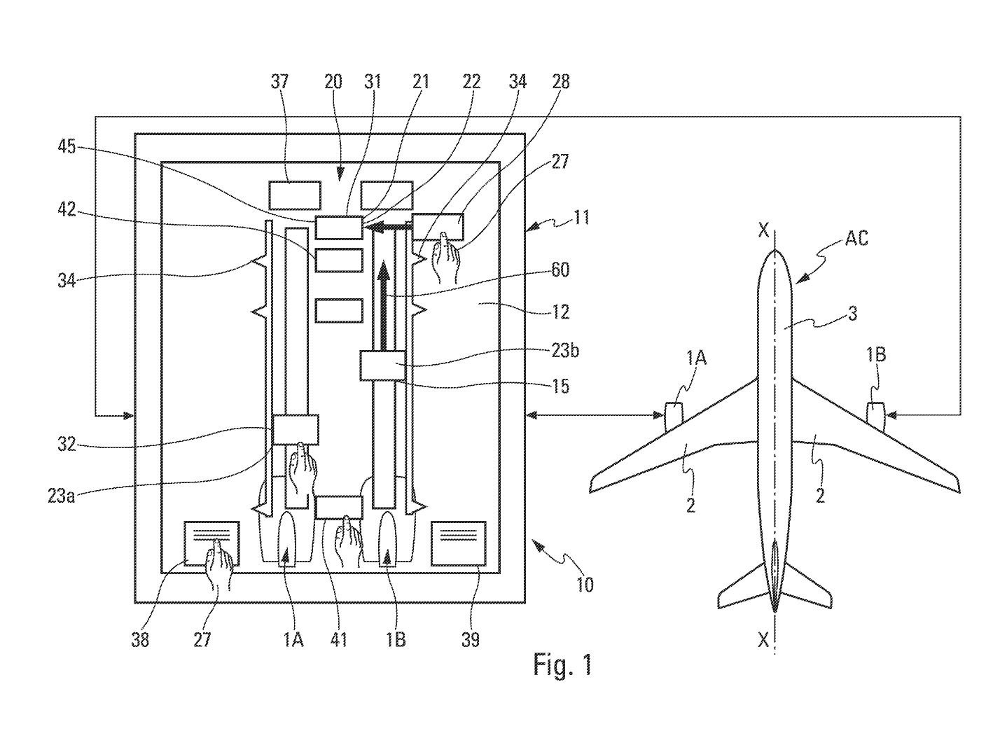

FIG. 1 shows in plan view an aircraft AC, in particular a transport airplane, comprising two engines 1A and 1B suspended one on each of the two wings 2 of the aircraft symmetrically with respect to the fuselage 3 of the aircraft AC of longitudinal axis X-X.

The speed of the engines 1A and 1B of the aircraft AC can be controlled by way of a device 10.

As shown in FIG. 1, this device 10 includes a display unit 11 configured to display, on at least one display screen 12 installed in the cockpit, indications regarding operation and at least the current engine speed 15 of one or more of the engines of the aircraft AC. The device 10 makes it possible to control the engine speed of the two engines 1A and 1B sketched on the screen 12.

In accordance with the invention, the display unit 11 is configured, in addition, to display simultaneously on the screen 12 a set 20 of graphic elements including at least one graphic element 21, the graphic element or elements 21 being configured to be able to be actuated and activated by an operator so as to control at least one engine speed 15 of an engine and of the two engines 1A and 1B in the example considered.

In a preferred embodiment the screen 12 is a touchscreen on which the set 20 of graphic elements is displayed. Each of the graphic elements 21 of the set 20 can be actuated by direct contact on the screen 12 (touch) at the location of the graphic element 21. The graphic elements 21 are preferably controlled by digital contact of the operator, of which a hand 27 is shown schematically in FIG. 1 by way of illustration (in conjunction with a number of graphic elements 21).

In another embodiment, the device 10 additionally includes control units (not shown), which are connected to the screen 12 (by a conventional connection of the cable type or based on electromagnetic waves) and which can be actuated by an operator so as to control the movement of a conventional cursor intended to act on the graphic elements 21 and/or on the movement of some of these graphic elements 21.

The display unit 11 is configured to display on the screen 12 at least one of the following indications, detailed below and regarding the operation of at least one of the motors 1A and 1B:
the current engine speed 15;
a selective engine speed change mode 31;
a movable engine speed change mode 32;
a level of preconfigured engine speeds 34;
a difference 60 between a selected engine speed and the current engine speed 15;
a value 37, in percentage, of the current engine speed in relation to a theoretical maximum engine speed; and
an automatic or guided operating mode.

The device 10 makes it possible to control the engine speeds in guided mode or in automatic mode, each engine 1A, 1B being managed independently. The device 10 to this end includes a graphic activation element 38, 39 per engine 1A, 1B. Each of the graphic activation elements 38 and 39 is configured to be actuated so as to select independently, for each engine, a guided speed control mode or an automatic speed control mode. In the example illustrated in FIG. 1, the engine 1A located to the left in FIG. 1 is in guided mode, whereas the engine 1B located to the right in FIG. 1 is in automatic mode.

The guided mode allows the operator to select the engine speed that he wishes to apply to the engine, whereas the automatic mode uses an installed computer to automatically change the engine speed depending in particular on the current flight data. Each of the graphic activation elements 38 and 39 makes it possible to activate the automatic mode or the guided mode independently for each engine.

The set 20 of graphic elements includes at least one movable graphic element 23a, 23b displaying the current speed. The graphic element 23a, 23b is movable on the screen 12 by the operator and is configured to control the transition from the current engine speed to any engine speed. This arbitrary engine speed is defined between a minimal engine speed IDLE 41 and a maximum engine speed TOGA 45 and is dependent on the position of the movable graphic element 23a, 23b on the screen 12. This operating mode is illustrated in FIG. 1 on the control of the engine speed of the engine 1A. The operator may move the movable graphic element 23a, 23b where he wishes between the minimum speed IDLE 41 and the maximum speed TOGA 45 by contact with the screen 12 at the engine speed value he wishes to give the engine. In other words, the engine speed is shown on a scale of values, and the selection of a point of the scale of values between the minimum and the maximum (for example 50%) drives a change of the value of the engine speed to reach the level corresponding to the selected point of the scale. To do this, the operator may move the movable graphic element 23a, 23b by moving his hand over the screen 12, as illustrated in FIG. 1, or by using a cursor or a wheel forming part of a control unit (not shown) as indicated before.

The set 20 of graphic elements includes at least one graphic selection element 22 configured to control the transition from the current engine speed to one of the preconfigured engine speeds 31. Thus, when the operator selects and activates the graphic selection element 22, the engine speed changes by passing from the current engine speed 15 to the preconfigured engine speed 31 corresponding to the graphic selection element 22 thus activated.

The graphic selection element or elements 22 is/are configured to select, respectively, at least some of the following preconfigured engine speeds:
the slowed speed (“IDLE”) 41;
a maximum continuous thrust MCT 42;
a reduced thrust takeoff speed FLEX TO (“flexible takeoff);
a slowed go-around speed GA SOFT (“go-around soft”);
the maximum takeoff and go-around speed TOGA 45 (“takeoff go-around”);
an aircraft climbing phase speed CLB (“climb”);
an automatic engine speed regulation intermediate speed A/THR (“automatic thrust”).

The activation of a graphic selection element 22 drives the change of the engine speeds of the two engines 1A and 1B of the aircraft AC toward the selected preconfigured engine speed 31. Thus, with the aid of a sole graphic element, the operator changes the engine speed of two engines 1A and 1B of the aircraft AC.

The set 20 of graphic elements also includes a graphic limitation element 28 indicating the maximum engine speed that each of the engines 1A and 1B can reach, corresponding in FIG. 1 to the maximum speed TOGA 45.

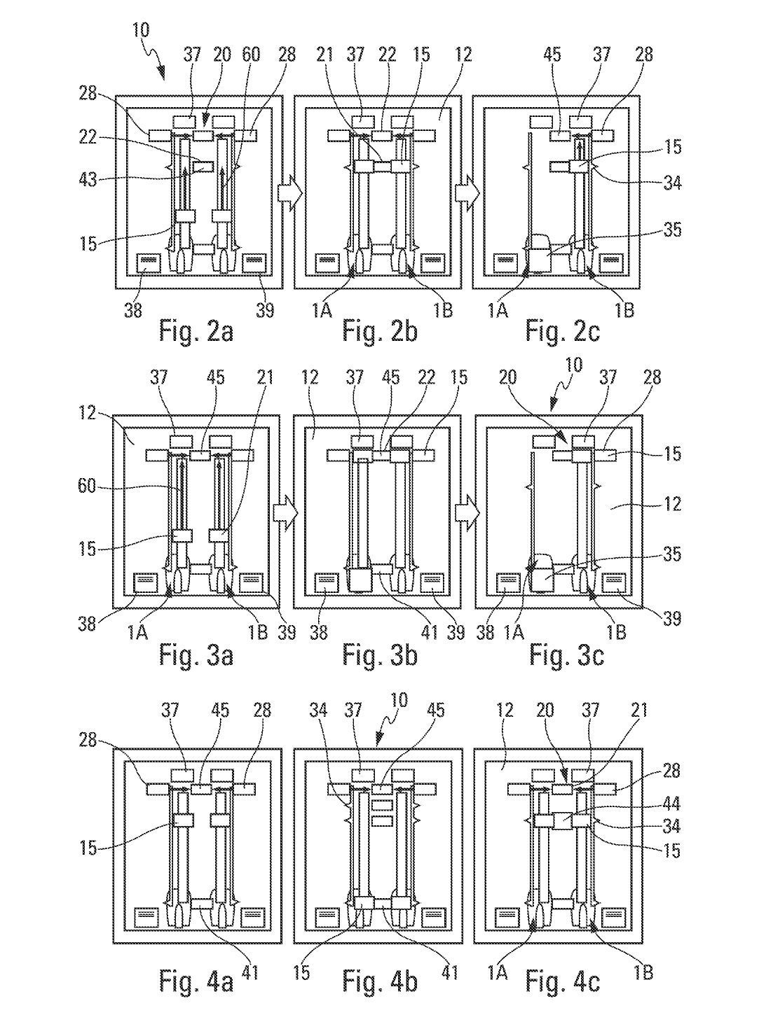

FIGS. 2a, 2b and 2c schematically show the device 10, illustrating the control of the engine speed of the engines 1A and 1B during takeoff of the aircraft AC. In these figures the automatic mode is selected thanks to the activation of the graphic activation elements 38 and 39. In FIG. 2a the value 37 of the current engine speed 15 of the two engines 1A and 1B is at 25% and transitions automatically to the level of the preconfigured speed FLEX TO 43, as illustrated in FIG. 2b, corresponding to a value 37 of the engine speed of 75%. The device 10 also displays the difference between the targeted engine speed (FLEX TO) and the current engine speed (25%) by arrows referenced 60. In the event of failure of an engine 1A when the engine speeds are at the preconfigured speeds FLEX TO 43, as illustrated in FIG. 2b, it is possible to increase the engine speed of the engine 1B continuing to operate, in a guided or automatic manner (FIG. 2c). The device 10 indicates when one 1A of the engines is faulty by way of a graphic fault element 35.

FIGS. 3a, 3b and 3c schematically illustrate the device 10, illustrating the control of the engine speed between the current engine speed 15 and a maximum engine speed TOGA 45. In these figures the automatic mode is selected thanks to the activation of the graphic activation elements 38 and 39. In FIG. 3a the value 37 of the engine speed of the two engines is at 25% and transitions automatically to the level of the preconfigured engine speed TOGA 45 corresponding to a value of 98.5% as illustrated in FIG. 3b. The device 10 also displays the difference between the targeted engine speed (TOGA) and the current engine speed (25%) by arrows referenced 60. In the event of a fault of one 1A of the engines, the engine speed of the engine 1B continuing to operate may remain at the maximum speed TOGA 45, as illustrated in FIG. 3c.

FIGS. 4a, 4b and 4c schematically show the device of FIG. 1, illustrating the control of the engine speed in navigation phase (FIG. 4a), in descent phase (FIG. 4b), and soft go-around phase (FIG. 4c). In these figures the automatic mode is selected thanks to the activation of the graphic activation elements 38 and 39. In FIG. 4a, showing an engine speed during stable navigation, the value 37 of the engine speed of the two engines 1A and 1B is at 82%. In an automatic operating mode this value may vary depending on flight data, in particular depending on current parameter values of the aircraft AC, of the engines 1A and 1B and/or of the environment. FIG. 4b illustrates an example of a descent phase of the aircraft AC. The engine speed of the two engines 1A and 1B then drops to the minimum speed IDLE 41 automatically. FIG. 4c illustrates the activation of a preconfigured speed GA SOFT 44 making it possible to increase the engine speed as smoothly as necessary.

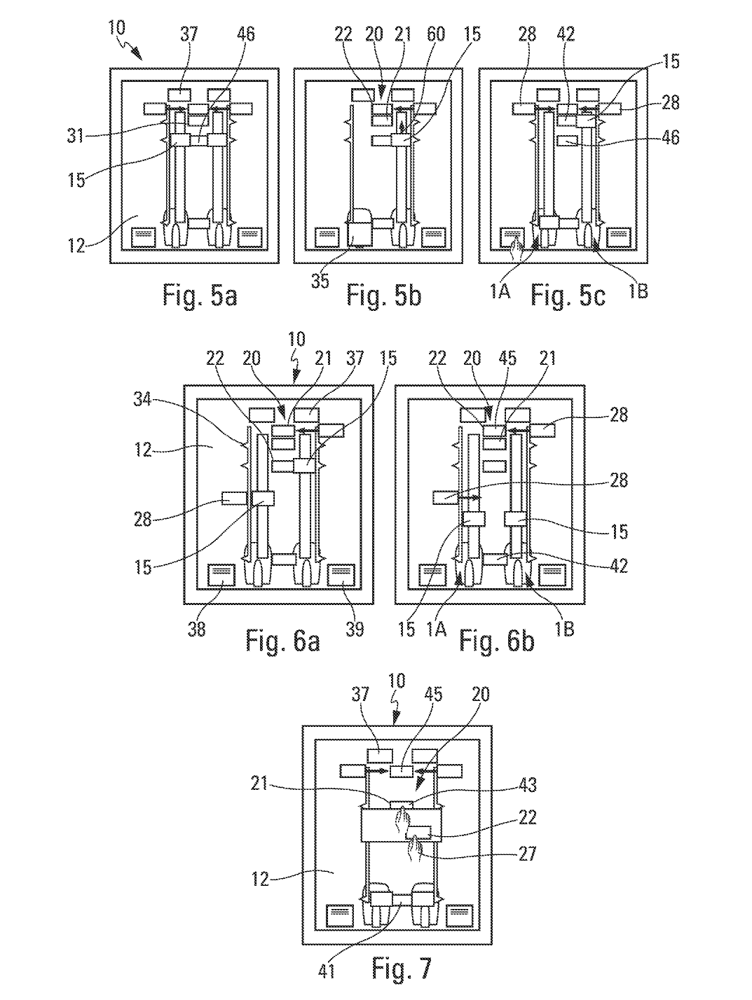

FIGS. 5a, 5b and 5c schematically show the device 10, illustrating the control of the engine speed in the climbing phase of the aircraft AC. In FIG. 5a the preconfigured engine speed CLB 46 is activated. The value 37 of the engine speed is then at 75%, for example. In the event of a failure of one 1A of the engines as illustrated in FIG. 5b, the engine speed of the other engine 1B can increase automatically in order to transition from the engine speed CLB 46 to the speed MCT 42 as illustrated in FIG. 5c. The device 10 also displays the difference between the targeted engine speed MCT 42 and the current engine speed CLB 46 by arrows referenced 60.

FIGS. 6a and 6b schematically show the device 10, illustrating the engine speed when the engine speed of one of the engines is limited. As can be seen in FIG. 6a, the engine speed of the engine 1A is limited and the screen 12 indicates this information by way of the graphic limitation element 28, in particular thanks to its positioning on the screen 12. The activation of a graphic selection element 22 corresponding to an engine speed greater than the limit speed then drives:
the transition from the current engine speed 15 to the limit speed for the first engine 1A;
the transition from the current engine speed 15 to the preconfigured engine speed 31 corresponding to the activated graphic selection element 22, for the other engine 1B.

By contrast, if the preconfigured engine speed 31 corresponding to the activated graphic selection element 22 is below the limit, as illustrated in FIG. 6b, the engine speed of the two engines 1A and 1B will be identical.

FIG. 7 schematically shows the device 10, illustrating the control of the engine speed of the engines 1A and 1B when the aircraft AC is on the ground. The operator has the choice of the type of engine speed that he desires for takeoff, for example the engine speed FLEX TO 43 or the engine speed TOGA 45.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for controlling a thrust of at least one engine of an aircraft, referred to as engine speed, the device comprising:
a display unit configured to display, on at least one display screen of the cockpit, indications regarding operation and at least the current engine speed of the engine of the aircraft,
the display unit additionally being configured to display simultaneously, on the screen, a set of graphic elements including at least one graphic element,
the at least one graphic element being configured to be able to be operated and activated by an operator to control at least one engine speed,
the set of graphic elements including:
at least one graphic selection element configured to control a transition from a current engine speed to a preconfigured engine speed and
at least one movable graphic element movable on the screen by an operator and configured to control the transition from the current engine speed to any engine speed, defined between a minimal engine speed and a maximum engine speed and dependent on a position on the screen of the at least one movable graphic element.

2. The device as claimed in claim 1, wherein said screen is a touchscreen on which said set of graphic elements is displayed, each of said graphic elements being able to be actuated by direct contact with said touchscreen at the location of said graphic element.

3. The device as claimed in claim 1, wherein said at least one graphic selection element is configured to select, respectively, at least one of the following preconfigured engine speeds:
a slowed speed;
a maximum continuous thrust;
a takeoff speed with reduced thrust;
a slowed go-around speed;
a maximum takeoff and go-around speed;
an aircraft climbing phase speed; and
an automatic engine speed regulation intermediate speed.

4. The device as claimed in claim 1, said device being configured to control the speed of at least two engines, said graphic selection element being configured to control the transition from the current engine speed to a preconfigured engine speed for all of said engines.

5. The device as claimed in claim 4, said device being configured so that, in the event of a situation limiting the speed of a first of the engines to a limit speed, the activation of a graphic selection element corresponding to an engine speed greater than the limit speed drives the transition from the current engine speed to the limit speed for this first engine and to the greater engine speed corresponding to said activated graphic selection element for the other engine.

6. The device as claimed in claim 4, said device being configured, in the event of failure of a first of the engines, to automatically control the rise of the engine speed of at least one other of the engines.

7. The device as claimed in claim 1, said device being configured to control the speed of at least two engines, wherein said set of graphic elements includes a graphic activation element per engine, each of the graphic activation elements being configured to be actuated so as to select, independently for each engine, a guided speed control mode or an automatic speed control mode.

8. The device as claimed in claim 1, wherein said display unit is configured to display at least one of the following indications regarding the operation of the engine:
a current engine speed;
an engine speed change mode;
a level of at least one preconfigured engine speed;
a difference between a selected engine speed and the current engine speed;
a value, in percentage, of the current engine speed in relation to a theoretical maximum engine speed;
an automatic or guided operating mode.

9. A method for controlling a thrust of at least one engine of an aircraft with the aid of a device as defined in claim 1, comprising the steps:
actuating at least one graphic element displayed on the screen of the display unit of said device,
controlling a corresponding engine speed upon the actuation of a graphic element.
